(19) United States
(12) Patent Application Publication
(10) Pub. No.: US 2026/0120245 A1
(43) Pub. Date: Apr. 30, 2026

(54) Method for training an image processing system with a machine learning model for performing a virtual multi-angle reconstruction of image stacks recorded with a light sheet microscope

(71) Applicant: Carl Zeiss Microscopy GmbH, Jena (DE)

(72) Inventors: Manuel AMTHOR, Jena (DE); Daniel HAASE, Zöllnitz (DE); Markus NEUMANN, Unterschleißheim (DE); Volker DOERING, Jena (DE); Thomas KALKBRENNER, Jena (DE)

(21) Appl. No.: 19/367,909

(22) Filed: Oct. 24, 2025

(30) Foreign Application Priority Data
Oct. 28, 2024 (DE) DE 102024131391.9

(51) Int. Cl. G06T 5/50; G02B 21/36; G06T 5/60; G06T 7/00

(52) U.S. Cl. CPC G06T 5/50; G02B 21/365; G06T 5/60; G06T 7/0002; G06T 2207/10056; G06T 2207/10064; G06T 2207/20081; G06T 2207/20084; G06T 2207/30168

(57) ABSTRACT

A method for training an image processing system with a machine learning model to perform a virtual multi-angle reconstruction of image stacks recorded with a light-sheet microscope. The method includes: recording at least one light-sheet fine stack comprising multiple image stacks at different illumination angles; determining target outputs from the fine stack, the model, and a classical multi-angle reconstruction; determining learning inputs from a light-sheet coarse stack comprising one or more image stacks at different illumination angles using the model and the classical reconstruction; creating an annotated dataset of the target outputs and learning inputs; and optimizing the model for the virtual multi-angle reconstruction based on the dataset. The light-sheet coarse stack has fewer images than the fine stack, and a virtual reconstruction produced by the trained model exhibits fewer image artifacts than a reconstructed image stack computed from the same coarse stack by the classical multi-angle reconstruction.

### RELATED APPLICATIONS

This application claims priority to German Patent Application No. DE 10 2024 131 391.9, filed on Oct. 28, 2024, which is incorporated herein by reference in its entirety.

### BACKGROUND OF THE INVENTION

Light Sheet Fluorescence Microscopy (LSFM) is an optical fluorescence microscopy technique which is used for rapid and high-resolution imaging of biomedical samples, which reduces the negative effects due to photobleaching and light-induced stress in the samples, since only a thin region in the samples is always exposed by means of a light sheet. Because the light sheet used is so thin, sample structures contained in LSFM samples with high absorption or scattering or low spectral transmittance in the samples cause image artifacts, in particular stripe artifacts, also called shadows, which lead to a deterioration of an image quality, in particular in sample regions which lie behind these sample structures with respect to the propagation direction of the light sheet.

Various methods have been developed in the prior art in order to eliminate the stripe artifacts. These include both hardware-based solutions and software-based solutions. For example, Dong, D. et al. in “Vertically scanned laser sheet microscopy”, J. Biomed. Opt 19(10), 1 (2014), describe a method in which a light sheet of a unidirectional light sheet microscope is displaced along a direction parallel to the light sheet and perpendicular to the propagation direction of the light sheet, whereby stationary stripe artifacts can be eliminated relative to the optics.

Dodt, H. U. et al. in “Ultramicroscopy: three-dimensional visualization of neuronal networks in the whole mouse brain,” Nat. Methods 4(4), 331-336 (2007), describe a bidirectional light sheet microscope in which two parallel light sheets from opposite sides of a sample illuminate the sample in order to reduce the stripes.

Huisken, J. et al. in “Even fluorescence excitation by multidirectional selective plane illumination microscopy (mSPIM),” Opt. Lett. 32(17), 2608-2610 (2007), describe a method in which a sample is illuminated from a plurality of different illumination directions and the plurality of resulting images are then averaged in order to eliminate resulting stripes or shadows. The results are very promising, but the light exposure also increases due to the multi-angle illumination of the sample, which is why this method, depending on a light sensitivity, cannot be applied to any samples.

Even if the methods described above can partially eliminate the resulting stripe artifacts, for example Tainaka, K. et al. in “Whole-body imaging with single-cell resolution by tissue decolorization,” Cell 159(4), 911-924 (2014) show that in particular samples with low brightness and samples with a very high density can still be impaired by stripe artifacts, even if the methods described above are used for eliminating the stripe artifacts or modifications thereof.

A somewhat different approach is followed by Wei et al. in “Elimination of stripe artifacts in light sheet fluorescence microscopy using an attention-based residual neural network”, Biomed Opt Express. 2022 Mar. 1; 13(3): 1292-1311, which train a modified U-net for eliminating stripe artifacts. A training data set for training the U-net comprises, as target outputs, stripe-free training images which were recorded with a special light sheet microscope. As training inputs, the training data set comprises augmented training images which were calculated from the stripe-free training images by means of a disturbance model and have different artificially generated stripe artifacts.

The various described methods for eliminating shadows or stripe artifacts deliver good results for their respective special application scenarios. However, the prior art does not provide a method with which stripe-free or shadow-free image data can be provided for any sample types with the lowest possible light exposure.

### SUMMARY OF THE INVENTION

The invention is based on the objective of providing a method, in particular an automated method, with which an image processing system for performing a virtual multi-angle reconstruction can be trained, which enables the creation of stripe-free or shadow-free images, in particular of image stacks with a high quality, with simultaneously low sample exposure. Furthermore, the invention achieves the object of providing a method for creating stripe-free or shadow-free images, in particular of image stacks with a high quality with simultaneously low sample exposure. In addition, the invention achieves the object of providing an image processing system, in particular comprising an imaging device, a computer program and a computer-readable storage medium, with which the methods can be performed.

The invention relates to a method for training an image processing system with a machine learning model for performing a virtual multi-angle reconstruction of image stacks recorded with a light sheet microscope, a method for performing a virtual multi-angle reconstruction, an image processing system for performing the method and a computer program product.

One or more objects are achieved by the subject matters of the independent claims. Advantageous developments and preferred embodiments form the subject matter of the dependent claims.

An aspect of the invention relates to a method for training an image processing system with a machine learning model for performing a virtual multi-angle reconstruction of image stacks, in particular a sample of a sample type, recorded with a light sheet microscope, comprising:
recording at least one light sheet fine stack of a sample, wherein the light sheet fine stack comprises a plurality of image stacks and for different ones of the image stacks a light sheet shines through the sample at a different angle,
determining target outputs based on the light sheet fine stack, the machine learning model and a classical multi-angle reconstruction,
determining learning inputs based on a light sheet coarse stack, the machine learning model and the classical multi-angle reconstruction, wherein the light sheet coarse stack comprises a plurality of image stacks and for different ones of the image stacks the light sheet shines through the sample at a different angle,
creating an annotated data set comprising the target outputs and the learning inputs,
optimizing the machine learning model for performing the virtual multi-angle reconstruction based on the annotated data set, characterized in that
the light sheet coarse stack comprises fewer images than the light sheet fine stack, in particular fewer image stacks, and a virtual reconstruction determined by means of the virtual multi-angle reconstruction has fewer image artifacts than a reconstructed image stack determined from the light sheet coarse stack by means of the classical multi-angle reconstruction.

In the following, samples can be any objects, fluids or structures. Each sample is suitably arranged and fixed in the optical path of a microscope by means of a sample carrier.

In the following, images refer in particular to microscope images, in particular microscope images which were recorded with a light sheet microscope. Furthermore, the images also comprise processed images, for example images processed with a machine learning model. In particular, image data comprise both individual images and image stacks and a plurality of image stacks recorded with different exposure angles, which are recorded for example with light sheet microscopes. Furthermore, images can comprise image data and time series of images or image stacks. In particular, images can also comprise depth information in addition to color information and brightness information.

In the following, a processing model refers to a model configured for processing input data and for outputting result data, sometimes also referred to as output data. The processing model can be a classic model which uses, for example, classic optimization or analysis methods or has been created for the use thereof. Likewise, the processing model can be a model trained by means of a learning method, it is then also referred to as machine learning model.

In the following text, a virtual processing mapping is understood to mean processing of image data carried out using a trained machine learning model. A virtual processing mapping corresponds respectively to a classical processing mapping implemented by means of optimization or analysis methods. In particular, in the following text, a distinction is made between a virtual multi-angle reconstruction carried out using a machine learning model trained for this purpose and a classical multi-angle reconstruction carried out using a classical processing model.

In the following, an image stack, sometimes also referred to only as a stack or also as a z-stack, refers to one or more images offset in height to one another, which are in particular registered or registerable to one another, i.e. identical points in the sample are mapped onto identical points in the images of the image stacks.

In the following, a light sheet fine stack comprises a plurality of image stacks of a sample, wherein the image stacks are each recorded with a different illumination direction or a light sheet shines through or illuminates the sample at a different illumination angle or at a different angle for short. A light sheet fine stack in this case comprises more images than a light sheet coarse stack, in particular a distance between the images of the light sheet coarse stacks is larger, in particular twice as large, three times as large or four times as large as in the light sheet fine stack. Alternatively, an angle offset between the different illumination angles in the light sheet coarse stack can be larger than in the light sheet fine stack, for example twice as large, three times as large or even four times as large, in particular the light sheet coarse stack can be a proper subset of the light sheet fine stack, for example some of the images or some of the image stacks of the light sheet fine stack are not recorded in the light sheet coarse stack when assembling the light sheet coarse stack.

In the following, learning inputs refer to data used in the training of a machine learning model which are input into the machine learning model, a training data set, also referred to as annotated data set, comprises target outputs in addition to the learning inputs.

In the following, target outputs refer to data used in the training of a machine learning model for carrying out a processing mapping, to which result outputs output by the machine learning model based on the learning inputs are to be adapted. The approximation is carried out with the aid of an objective function.

In the following text, a classical multi-angle reconstruction refers to a classical image processing, in which one or more images, in particular one or more image stacks, which were recorded at different illumination angles, are combined. In particular, shadow effects occurring in the classical multi-angle reconstruction are eliminated, for example, by averaging.

In the following text, image artefacts, in particular stripe artefacts or shadow artefacts, refer to stripe-shaped image regions with an image signal reduced compared to neighboring image regions. Such shadow artefacts occur behind opaque or partially opaque sample structures in images recorded with light sheet microscopes; they arise when sample structures absorb light of the light source to such an extent that, proceeding from the light source, a stripe with reduced image signal forms behind the light source.

In the prior art, for training a machine learning model, a training data set is calculated from image data without shadow artefacts by means of an augmentation. However, a suitable augmentation can be carried out here in particular only if image data without shadow artefacts can be generated or recorded, and in addition a very specific type of sample is used in the described scenario. In further methods known from the prior art, samples are subjected to a high light exposure by multiple exposure from different directions in order to obtain artefact-free or at least artefact-reduced image data.

The inventors of the present invention have recognized that a light exposure can be reduced very considerably by training respective special machine learning models for different sample types individually for the different sample types by initially recording or generating shadow-free or artefact-free image data with the aid of multiple exposures, determining training data sets based on the artefact-free image data and training a machine learning model on the basis of the determined training data sets such that it can generate shadow-free or artefact-free image data from image data with shadow artefacts, in particular for samples of the respective sample type.

For this purpose, light sheet coarse stacks are determined or recorded for the training, a machine learning model for performing a virtual multi-angle reconstruction is trained on the basis of the light sheet coarse stacks and the artifact-free target outputs determined based on light sheet fine stacks. A virtual processing mapping trained in this way or a machine learning model trained in this way can then calculate result data based on the light sheet coarse stacks which, like the practically artifact-free target outputs, have no or at least considerably fewer stripe artifacts than the images of the light sheet coarse stack.

The determining of the learning inputs preferably comprises
recording the light sheet coarse stack, wherein when recording the light sheet coarse stack fewer different image stacks, fewer different angles or fewer images are recorded per image stack compared to the light sheet fine stack,
determining the light sheet coarse stack from the light sheet fine stack, wherein the light sheet coarse stack is a proper subset of the light sheet fine stack, preferably the light sheet coarse stack comprises only every second, third or fourth of the image stacks recorded when recording the light sheet fine stack or comprises for each image stack of the light sheet coarse stack only every second, third or fourth image of the respective image stack, particularly preferably the light sheet coarse stack comprises only a single image stack of the image stacks of the light sheet fine stack.

If the light sheet coarse stack is a proper subset of the light sheet fine stack, a light loading during the determining of the training data is particularly low since the light sheet coarse stack does not have to be recorded separately, as a result of which the light loading during the training can be reduced and the sample can be preserved.

The method preferably comprises, before recording the light sheet fine stack, determining one or more recording parameters depending on a sample type for which the training is performed such that regions in the sample which are arranged behind opaque or partially opaque sample structures are illuminated in at least one of the recorded image stacks or are partially illuminated at least in a plurality of the image stacks of the light sheet fine stack. The acquisition parameters comprise one or more of the following parameters:
a height offset of height-offset images in an image stack,
a number and an angular distance of the different angles,
an exposure spectrum,
fluorophores used,
context information; and furthermore
   in particular the sample type is determined based on one or more of the following properties of opaque or partially opaque sample structures:
an extent of the sample structures,
an opacity,
a spectral transmittance,
usable fluorophores, and
a density in the sample of the sample type.

By virtue of the fact that the recording parameters are selected depending on the sample properties, it is respectively possible to select optimal recording parameters for each sample type. At the same time, the sample can be preserved accordingly in that no unnecessary recordings of the sample are recorded. If, for example, a sample comprises a particular number of opaque structures, the sample must be illuminated particularly finely, i.e. a particular number of different image stacks must each be recorded with a different illumination angle in order to illuminate the sample as well as possible everywhere.

The machine learning model is preferably a stage processing model or an overall processing model, wherein the stage processing model comprises a detail enhancement model and a reconstruction model, the reconstruction model is configured to calculate the classical multi-angle reconstruction, the detail enhancement model is trained by means of the annotated data set to execute a detail enhancement mapping, and performing the classical multi-angle reconstruction and the detail enhancement mapping in succession yields the virtual multi-angle reconstruction, depending on an order in which the detail enhancement model and the reconstruction model are applied, the detail enhancement model is either trained to map a reconstructed image stack, also referred to as reconstructed light sheet coarse stack, calculated from the light sheet coarse stack by means of the classical multi-angle reconstruction onto a reconstructed image stack, also referred to as reconstructed light sheet fine stack, calculated from the light sheet coarse stack by means of the classical multi-angle reconstruction or to map the light sheet coarse stack onto the light sheet fine stack, and determining the learning inputs and the target outputs depending on the order in which the detail enhancement model and the reconstruction model are applied comprises: selecting a reconstructed light sheet coarse stack or selecting a reconstructed light sheet fine stack as the learning inputs and selecting a reconstructed light sheet fine stack or selecting a light sheet fine stack as the target outputs, and if the machine learning model is the overall processing model, the overall processing model is directly trained by means of the annotated data set to perform the virtual multi-angle reconstruction, in particular the virtual multi-angle reconstruction comprises the detail enhancement mapping and the classical multi-angle reconstruction, and determining the annotated data set comprises: selecting a light sheet coarse stack comprising at least one image stack as the learning inputs and selecting at least one reconstructed image stack determined from the light sheet fine stack by means of the classical multi-angle reconstruction as the target outputs.

If the machine learning model is implemented as a stage processing model, then a detail enhancement mapping is trained in the training, the training of which detail enhancement mapping is simpler and less extensive than the training of an aggregate processing model. If the machine learning model is implemented as an aggregate processing model, then the processing is more efficient than in the case of the implementation as a stage processing model.

The determining of the target outputs from the light sheet fine stack preferably comprises:
calculating, by means of the classical multi-angle reconstruction, a plurality of candidate reconstructed stacks, wherein for each of the plurality of candidate reconstructed stacks a different set of reconstruction parameters of the classical multi-angle reconstruction is used, wherein by means of the used parameters for example a used reconstruction algorithm, a number of iterations in applying the reconstruction algorithm, used correction methods or correction parameters of the used correction method are selected,
checking the candidate stacks, in particular with reference to a quality of the classical multi-angle reconstruction, and
selecting a reconstructed light sheet fine stack from the candidate reconstructed stacks, in particular with reference to the quality of the classical multi-angle reconstruction.

By means of the selection of the reconstructed light sheet fine stack from the candidate stacks, it is possible to ensure that an optimally reconstructed image is used for the training depending on the sample type.

The optimizing of the machine learning model preferably comprises augmenting the annotated data set or simulating further data using a point spread function as well as the target outputs of the annotated data set, wherein the point spread function is, for example, a depth-variant point spread function.

By augmenting the data of the annotated data set, a database for the training can be increased and thus the training can be improved.

The augmenting in particular comprises, before the calculating of the target outputs, one or more of:
transforming the images of the light sheet fine stack or of the light sheet coarse stack or of both stacks, wherein the transforming comprises one or more of:
denoising,
de-blooming,
mirroring,
rotating,
scaling,
deforming by means of an elastic grid,
brightening,
darkening,
adjusting the gamma correction value,
vignetting,
an offset,
color inversion,
artificial noise,
sub-sampling,
masking,
blurring,
any filtering with a linear or non-linear filter,
sharpening,
an artifact removal mapping,
deconvolution,
histogram spreading,
down-sampling, and
inpainting of the images, wherein the transforming is carried out in particular using a transformation machine learning model trained for the respective transformation.

Preferably, after optimizing the machine learning model, the method further comprises checking the machine learning model whether the machine learning model is suitable for reconstructing the light sheet coarse stack by means of the learned virtual multi-angle reconstruction.

By virtue of the fact that the processing is checked with the machine learning model, it is possible to ensure that the virtual multi-angle reconstruction is carried out with a good quality by the machine learning model.

The recording of the at least one light sheet fine stack is preferably carried out at a specific location of the sample, in particular the specific location is not needed for recording further images of the sample, and in particular the specific location of the sample is automatically selected by the image evaluation system, for example in a predetermined region of the sample, as a result of which, for example, the specific location can be suitably selected such that light loading by the recording of the light sheet fine stack for the training does not already take place at the start of the experiment in regions which are particularly interesting, for example, in a later course of an experiment.

A further aspect according to at least one embodiment of the present invention relates to a method for performing a virtual multi-angle reconstruction of an image stack recorded with a light microscope with an image processing system comprising a machine learning model, comprising:
providing a machine learning model for performing the virtual multi-angle reconstruction, wherein a machine learning model is used which has been trained according to the method for training an image processing system according to any one of the preceding claims,
recording, by means of a light sheet microscope, a light sheet coarse stack to be processed, comprising at least one image stack of the sample of the sample type,
calculating a virtual reconstruction from the light sheet coarse stack by means of the virtual multi-angle reconstruction.

In conventional, classical multi-angle reconstructions, the recording light sheet microscope must record a multiplicity of image stacks at different illumination angles, as a result of which the sample under consideration can be heavily loaded. Because, according to the above method, only light sheet coarse stacks have to be recorded in order to create a high-quality reconstructed image stack or a high-quality virtual reconstruction, the method reduces the light load during the examination of samples.

Before calculating a virtual reconstruction, the above method preferably further comprises:
checking one or more machine learning models whether the machine learning models are suitable for reconstructing the light sheet coarse stack to be processed by means of the respectively learned virtual multi-angle reconstruction, and, if no suitable machine learning model is present:
performing the method described above for training an image processing system with the sample of the sample type, wherein in particular the recording of the light sheet fine stack takes place in a predetermined region of the sample and in particular the recording of the light sheet coarse stack to be processed takes place in a region of the sample different from the predetermined region.

By virtue of the fact that it is initially verified whether a suitable machine learning model has already been trained, an unnecessary recording of a light fine stack can be avoided, as a result of which a sample can be protected against unnecessary light loading. In particular, a plurality of machine learning models can be checked as described above, machine learning models to be checked can be determined, for example, on the basis of context information.

The checking of a reconstructed fine stack output by the machine learning model preferably comprises:
a manual verifying,
a comparison with example target images,
a determination of a quality metric, in particular based on image properties of the virtual reconstruction, for example image sharpness, edge sharpness, number of image artifacts such as stripe artefacts, in particular by means of a metric quality model, wherein the metric quality model is set up, in particular trained, for identifying image properties,
an inputting into a quality classification model that has been trained to identify well and poorly reconstructed image stacks,
verifying on the basis of image features such as, for example, image sharpness, noise level, blood flow, artefacts such as ring, stripe or shadow artefacts.

A further aspect according to one or more of the embodiments of the present invention relates to an image processing system comprising an evaluation device for performing the methods according to the aspects described above.

The image processing system preferably comprises an imaging device, in particular a light microscope.

A further aspect according to one or more of the embodiments of the present invention relates to a computer program product comprising commands which, when the program is executed by one or more computers, cause the latter to carry out the method according to any one of the aspects described above, the computer program product being in particular a computer-readable storage medium.

### BRIEF DESCRIPTION OF THE DRAWINGS

The invention is explained in more detail below on the basis of the examples illustrated in the drawings. The drawings show in:

FIG. 1 schematically an image processing system for training or for performing a virtual multi-angle reconstruction according to one embodiment;

FIG. 2 schematically an evaluation device for performing the training or the virtual multi-angle reconstruction with a machine learning model and an imaging device according to one embodiment;

FIG. 3 a schematic illustration of a machine learning model according to one embodiment;

FIG. 4 a schematic illustration of a method according to one embodiment;

FIG. 5 a schematic illustration of a method according to one configuration of one embodiment;

FIG. 6 a schematic illustration of a method according to a further embodiment;

FIG. 7 schematically an image processing system for use with the methods according to one or more embodiments;

FIG. 8 a schematic illustration for better understanding of a method according to one embodiment.

### DETAILED DESCRIPTION OF THE PREFERRED EMBODIMENTS

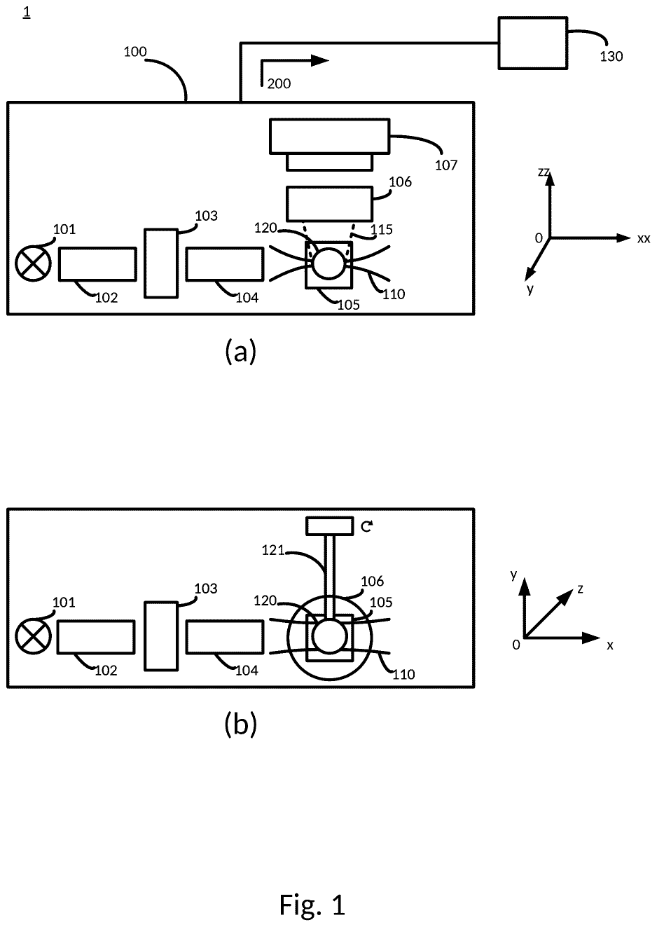

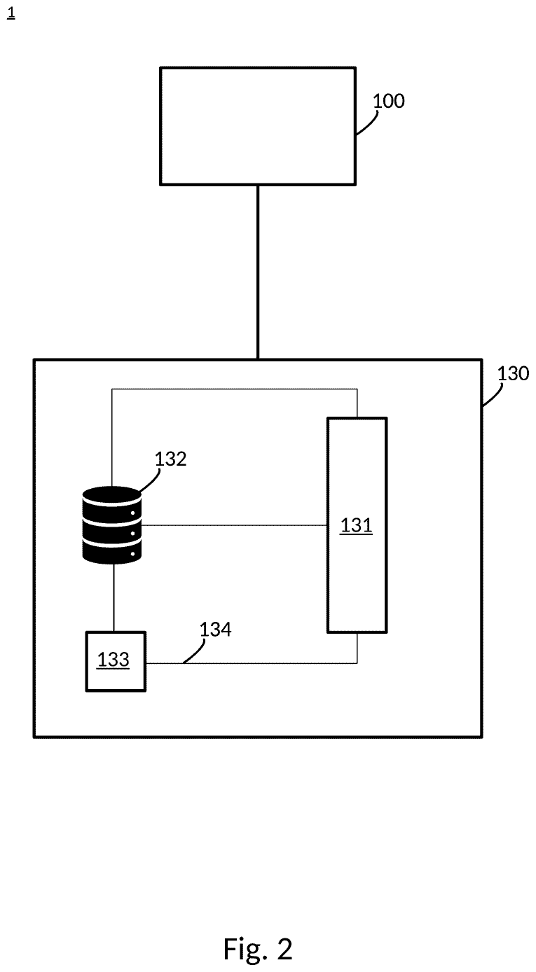

An exemplary embodiment of an image processing system 1, see FIG. 2, comprises an imaging device 100 and a control and evaluation device 130, referred to below as evaluation device 130. The evaluation device 130 is communicatively connected to the imaging device 100, for example to a wired or wireless communication link. The evaluation device 130 can evaluate image data 200 acquired with the imaging device 100 and control the imaging device 100, for example, based on the evaluated image data. The imaging device 100 according to the first embodiment is a light sheet microscope. FIG. 1 shows the basic components of the light sheet microscope in a schematic illustration of the imaging device 100, wherein the light sheet microscope is illustrated schematically once in a plan view and once in a side view. The imaging device 100 comprises a light source 101, a beam expander 102, a lens 103, an illumination objective 104, a sample chamber 105, a detection objective 106 and a camera 107.

The light source 101 is in particular a laser, for example a solid-state or gas laser; a laser beam generated by the laser is collimated and expanded by the beam expander 102. A lens 103, in particular a cylindrical lens, forms a light sheet 110 which is projected onto a sample 120 by the illumination objective 104 such that a focal point or a thinnest part of the light sheet 110 is located in the middle of the sample chamber 105. As a result of the use of a cylindrical lens, the laser beam expanded by the beam expander 102 is focused in particular along one direction; a so-called light disk, also called a light sheet 110, is formed which illuminates only one very thin sheet in the sample 120, therefore, light sheet microscopes are considered to be particularly gentle with respect to the light loading of samples 120. According to this embodiment, a light disk is formed in the light sheet microscope which is substantially parallel to the plane spanned by the x-axis and the y-axis.

The sample chamber 105 typically consists of optically clear glass walls and has an open top side through which the sample 120 can be introduced into the sample chamber 105 on a sample holder 121. The sample chamber 105 is filled either with a heated physiological solution for the imaging of living cells or with a cleaning liquid for fixed and cleaned tissue. The sample 120 is fastened to the rod-shaped sample holder 121. The sample 120 is moved into the light sheet 110 by means of the sample holder 120. Within the light sheet 110, the sample 120 is excited to fluoresce, wherein the sample 120 is excited only in the narrow light sheet 110, which is why image signals of the image background generally turn out to be lower in light sheet microscopes than in normal fluorescence microscopes.

The fluorescence light 115 emitted by the sample is collected in the detection objective 106 arranged perpendicular to the plane of the light sheet 110 and recorded by the camera 107. The image data 200 recorded by the camera 107 are forwarded to the evaluation device 130 and stored in a memory module 132 of the evaluation device.

If small, thin samples and a relatively thick light sheet 110 are used, a light sheet microscope can capture the sample 120 in real time. For samples which are larger than a local parameter of the light, the sample 120 is captured in a tile-wise manner and in a plurality of images offset in height with respect to one another along the z-direction. While in the case of usual microscopes the objective is often displaced along a z-direction in order to create a z-stack, in the case of light sheet microscopes the sample is displaced accordingly. In the case of a light sheet microscope, the narrow light sheet 110 and the focal position of the detection objective 106 are coordinated with one another such that the focal position lies precisely in the light sheet 110. If the focal position were to be adapted by shifting the detection objective 106, the position of the light sheet 110 would also have to be adapted; in addition, a coordination of the position of the light sheet 110 with respect to the focal position of the detection objective would thus be required, which would make the control more complicated.

The sample 120 can be displaced within the sample chamber along all three spatial directions; in addition, the sample can be rotated about the y-axis by means of the sample holder 121.

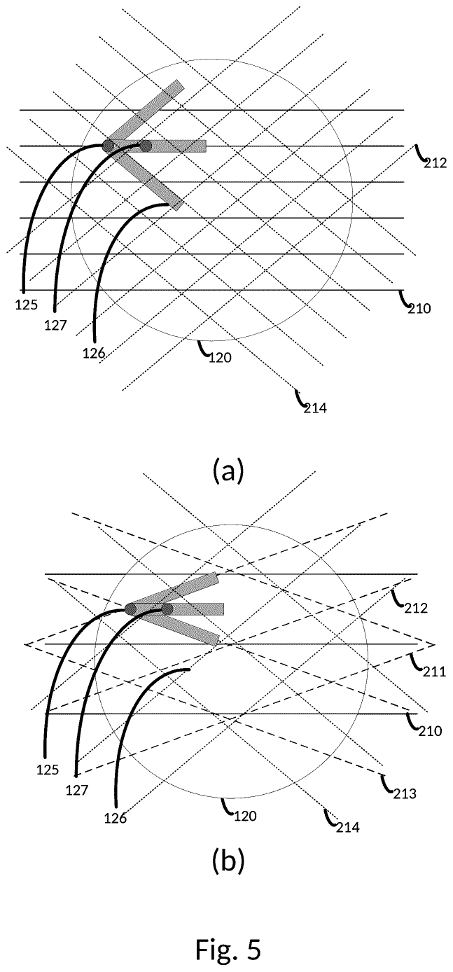

According to this embodiment, the evaluation device 130 can be connected to a monitor (not illustrated) on which the image data 200 can be displayed. The evaluation device 130 is configured to control the imaging device 100 to record image data 200 with the camera 107, to evaluate the recorded image data 200 with an evaluation module 131 and to store the image data 200 on a memory module 132 (see FIG. 5) of the evaluation device 130. The recorded image data 200 can be displayed on the monitor if required. The evaluation device 130 is configured to process or evaluate the recorded image data 200. The image data 200 comprise in particular individual images 205, image stacks 210, light sheet fine stack 220, light sheet coarse stack 230, reconstructed image stacks 240, virtual reconstructions 250 and virtual light sheet fine stacks 260.

In addition to the evaluation module 131 and the memory module 132, the evaluation device 130 also comprises the control module 133. The modules of the evaluation device 130 are connected to one another via channels 134, wherein they can exchange data with one another via the channels 134. The channels 134 are logical data connections between the individual modules. The modules can be designed both as software modules and as hardware modules.

The evaluation module 131 evaluates the input image data 200 and, on the basis of the evaluation, forwards information to the control module 133 or forwards the results of the evaluation to the memory module 132 for storage.

The memory module 132 stores the image data 200 recorded by the imaging device 100 and manages the data to be evaluated in the evaluation device 130.

The control module 133 can read the image data 200 from the memory module 132 and forward them to the evaluation module 131 for evaluation. In addition, the control module 133 can send control commands, also referred to as control information, to the imaging device 100. In particular, the control module 133 can be configured to generate the control information based on the information obtained from the evaluation module 131. In this case, the control information can control the imaging device 100 overall or only certain parts.

According to the present embodiment, the evaluation device is configured to read processing models from the memory module 132 and to process the image data 200 with the evaluation module 141 using the processing models. The processing models comprise, in particular, a classical processing model designed for performing a classical multi-angle reconstruction 135, and machine learning models 140, which can be trained for performing a virtual multi-angle reconstruction, or machine learning models 140 fully trained for performing the virtual multi-angle reconstruction.

In particular, the evaluation module 131 can comprise one or more machine learning models 140, which are each trained for different sample types for performing the virtual multi-angle reconstruction. In particular, the machine learning models 140 are implemented as neural networks.

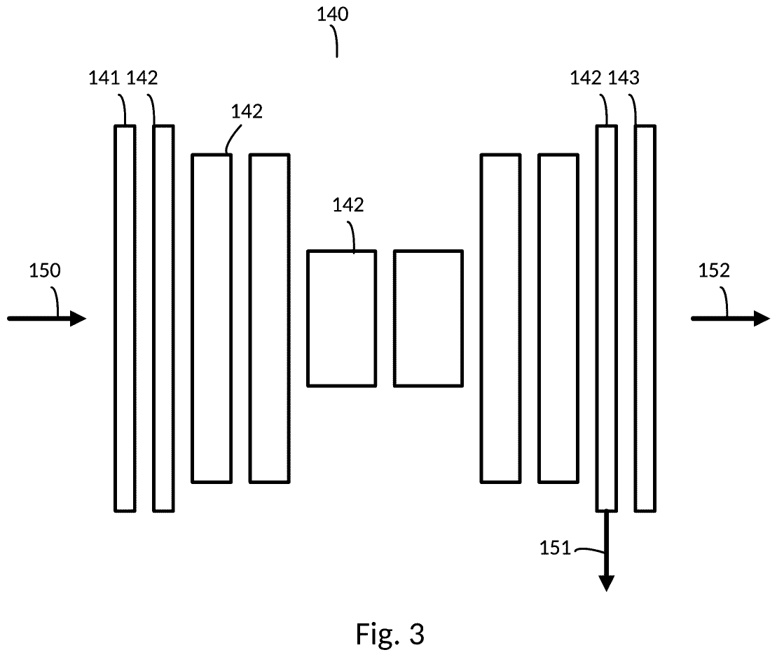

A machine learning model 140 (see FIG. 3) can be, in particular, a neural network with a plurality of slices. In particular, the machine learning model 140 has an input layer 141, one or a plurality of intermediate layers 142 and an output layer 143. Input data 150 which are processed by means of the input layer 141, the intermediate layers 142 and the output layer 143 can be input into the input layer 141, and the output layer 143 outputs result data 152. Depending on which type or implementation of machine learning model 140 is used, the form and extent of the input data 150 and of the result data 152 vary. For some machine learning models 140, intermediate outputs 151 can also be output.

In the following text, an input layer 141 refers to a first slice of a machine learning model 140 with a plurality of slices. In particular, a first slice of a neural network. According to the first embodiment, the machine learning model 140 is a U-Net, in particular a generative U-Net, which is embodied as an aggregate processing model. Light sheet coarse stacks 230 are input into the machine learning model 140 as input data 150.

The machine learning model 140 is trained in the training for carrying out the virtual multi-angle reconstruction. During the training of the machine learning model 140, the evaluation module 131, controlled by the control module 133, reads a part of the image data 200 of a training data set, wherein the training data set is, in particular, an annotated data set, from the memory module 132 and inputs training data into the respective machine learning model 140. The evaluation module 131 determines an objective function on the basis of the result data 152 of the machine learning model 140 and based on target data contained in the annotated data set and optimizes the objective function by adapting the model parameters of the machine learning model 140 based on the optimization of the objective function.

In particular, the optimization of the objective function is carried out by means of a stochastic gradient descent method. In the stochastic gradient descent method, only a small subset of the training data of the annotated data set, referred to as batch, is respectively used. For input data of the batch, based on result data 152 output by the machine learning model 140 and the target data of the annotated data set corresponding to the input data 150, the control module 133 determines the objective function, here a loss function, which captures a difference between the result data 152 and the target data. The control module 133 then calculates a gradient for each of the calculated objective functions with reference to the model parameters of the machine learning model 140, sums the calculated gradients over the batch and determines the mean value. From the mean value, the control module 133 determines updated model parameters for the machine learning model 140 by so-called back propagation. The machine learning model 140 is newly initiated by the control module 133 with the updated model parameters in the evaluation module 131 and a next step of the stochastic gradient descent method is carried out.

The training of the machine learning model 140 ends as soon as it is achieved by the optimization of the objective function that the objective function reaches a predetermined limit value.

If the training has been completed, the control module 133 stores the most recently used model parameters of the machine learning model 140 in the memory module 132, in particular together with context information, such that the machine learning model 140 just trained can be identified again later and can be initialized, for example, for further training or the inference.

As an alternative to the stochastic gradient descent method, other methods can also be used. In particular, any other desired training method can be used.

If the training of a machine learning model 140 is ended, the corresponding model parameters are stored in the memory module 132 and can be read out later in the inference for performing the learned virtual multi-angle reconstruction.

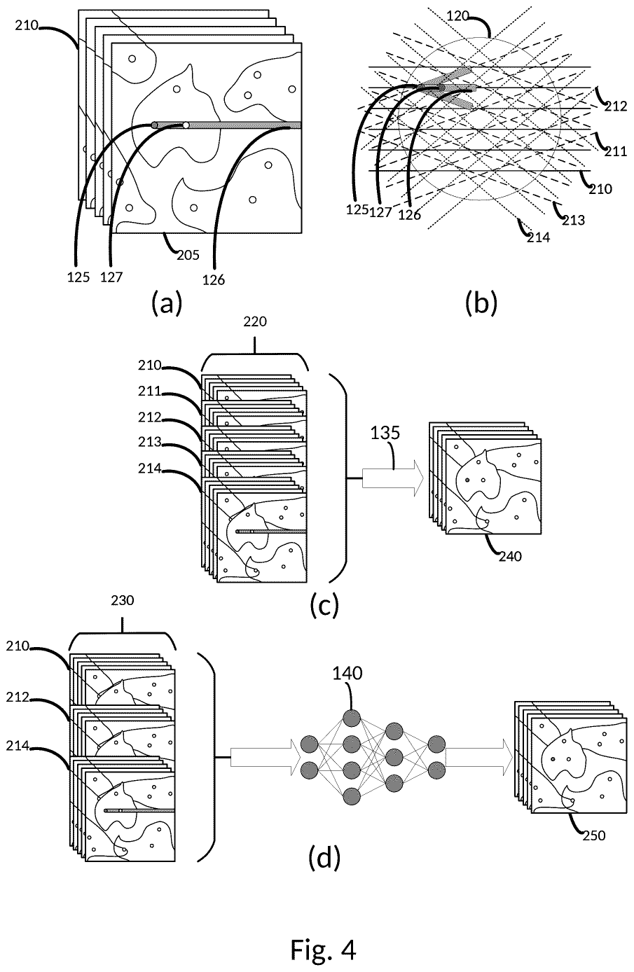

A method for performing the virtual multi-angle reconstruction with the image processing system 1 having a machine learning model 140 for images of a sample type according to the first embodiment is explained below (FIG. 4).

The method comprises a plurality of steps. According to a first step S1 “recording a light sheet coarse stack”, the camera 107 of the imaging device 100 records at least one light sheet coarse stack 230 in the sample under consideration, wherein the light sheet coarse stack 230 comprises at least one image stack 210. The recorded image data 200 are stored in the memory module 132.

Recording a light sheet stack with a light sheet microscope comprises, according to some embodiments of the present invention, recording a plurality of image stacks 210, wherein each image stack 210 comprises a plurality of images 205 offset in height with respect to one another, wherein, during the recording of the height-offset images 205, not only the focal position of the detection objective 106 in the sample is displaced, but, in addition, the position of the light sheet 110 in the sample is displaced. This can be realized, as described above, by shifting the sample 120, the focal position and the position of the light sheet 110 in the sample 120 thus remain compared with one another. Alternatively, however, light sheet 110 and detection objective 106 can also be displaced with respect to one another such that they are displaced jointly in the sample 120 along the observation direction, such that the focal position of the detection objective 106 is always illuminated by the light sheet 110.

As in the case of each image recording with a microscope, the light of the light sheet 110 is scattered at the different sample structures of the sample 120. Shadows are respectively formed behind the sample structures depending on the transmittance of the illuminated sample structures along the propagation direction of the light sheet 110. As only the very narrow light sheet 110 is illuminated in the sample 120 and a detection of the light takes place perpendicularly with respect to the light sheet 110, in the case of light sheet microscopes the light intensity in the shadow of opaque or partially opaque sample structures 125, referred to below as opaque sample structures 125, is particularly greatly reduced in relation to the light intensity in the light sheet 110, in this respect the schematic illustration in FIG. 4 (a). In particular in comparison with other types or types of microscopes in which in particular a large-area illumination is used, the light intensity behind opaque sample structures 125 is considerably reduced.

Objects within the shadow 126, also referred to as shadow objects 127, are therefore particularly poorly lighted or illuminated, which is why image signals of shadow objects 127 are only poorly visible in an image 205 or in a corresponding image stack 210 and, in particular, are only visible with a reduced image signal or a reduced intensity; this is illustrated by way of example or schematically with the image stack 210 illustrated in FIG. 4 (a), in which a shadow 126 virtually completely conceals a shadow object 127 in an uppermost image 205.

Therefore, when using light sheet microscopes for samples 120 in which shadows 126 occur, a plurality of image stacks 210 are often recorded, wherein the sample 120 is illuminated at a different angle for each of the different image stacks 210. This is illustrated schematically in FIG. 4 (b). Five different image stacks 210, 211, 212, 213 and 214 of the sample 120 are recorded, wherein the different lines and dashed lines each indicate the focal positions for the different image stacks 210 to 214 of the imaging device 100 in the sample 120 during the recording of the respective image stack 210 to 214. For the different image stacks 210 to 214, the sample 210 is therefore respectively illuminated at a different angle. This can be achieved in particular by a rotation of the sample 120 about the y-axis. In FIG. 4 (b), the shadows are respectively indicated only for the image stacks 210, 211 and 213 for the sake of clarity.

As can be seen in FIG. 4 (b), the shadow object 127 in the image stack 210 is arranged precisely in the shadow 126 of the opaque sample structure 125, but during the recording, for example, the image stacks 211 and 213 are no longer arranged precisely in the shadow 126. For the sake of clarity, only a single opaque sample structure 125 is always illustrated in FIGS. 4 (a) to (d), likewise respectively only one or a few shadows 126 and one shadow object 127.

In real samples 120, a number and a density, and also the geometric extents of the opaque sample structures 125 for different sample types, can differ greatly from one another. Accordingly, it may be necessary to respectively record a different number of image stacks 210 with different illumination angles, and a selected height offset of the height-offset images 205 of an image stack 210 to one another can also be selected depending on the sample type.

According to a second step S2 “verifying whether a suitable machine learning model is available”, the evaluation device 130 verifies whether the memory module 132 can provide a suitable, trained machine learning model 140 for performing the virtual multi-angle reconstruction for the sample type of the examined sample 120.

If the evaluation device 130 determines that no suitable machine learning model 140 is stored in the memory module 132, the imaging device 100 is instructed by the control module 133 to record a light sheet fine stack 220.

In the third step S3 “selecting a specific location in the sample”, a selection machine learning model independently selects a specific location of the sample 120 on the basis of the sample type. The selection machine learning model has been trained on the basis of specific locations for the recording of light sheet fine stacks 220 selected earlier by a user on comparable samples 120 to select the specific location for the recording of light sheet fine stacks 220. At the specific location, the imaging device 100 automatically records the light sheet fine stack 220, which comprises, for example, five image stacks 210 with different illumination angles. The recorded light sheet fine stack 220 is read out from the camera 107 and stored in the memory module 132.

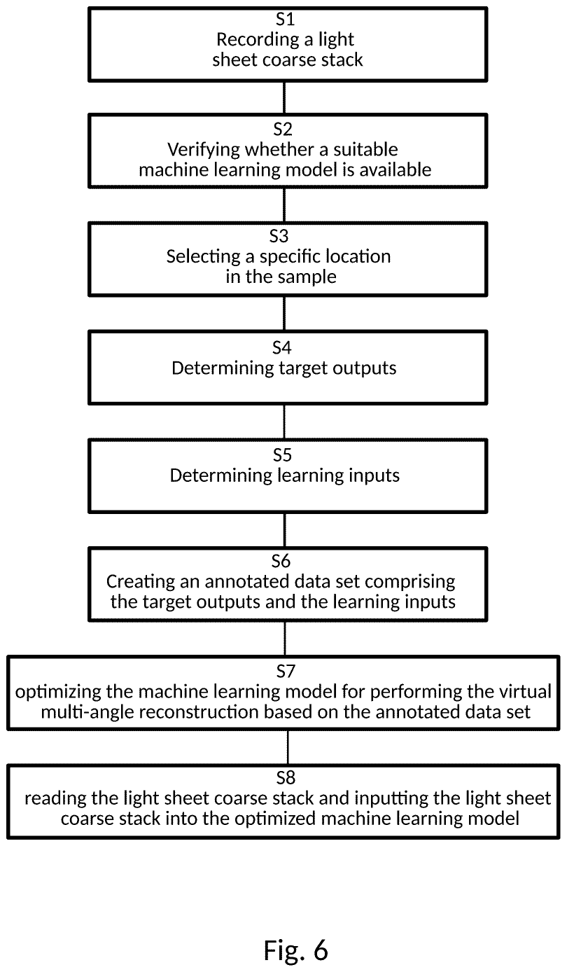

A light sheet fine stack 220 differs from a light sheet coarse stack 230 in that the light sheet fine stack 220 captures the sample 120 finer than the light sheet coarse stack 230, in particular the light sheet coarse stack 230 comprises fewer images 205 than the light sheet fine stack 220. In particular, the light sheet fine stack 220 comprises more image stacks 210 than the light sheet coarse stack 230, see here, for example, FIG. 6 (a), according to which a recording of the light sheet coarse stack 230 comprises a recording of only three image stacks 210, 212 and 214. Alternatively, however, the light sheet coarse stack 230 can also comprise, for example, fewer images 205 per image stack 210, that is to say a distance, also called height offset, between the height-offset images 205 of the image stack 210 is larger for the light sheet coarse stack 230 than for the light sheet fine stack 220, see in this respect, for example, FIG. 6 (b).

According to an alternative, a specific location can also be selected by a user, for example, in an overview image.

According to the step S4 “determining target outputs”, the evaluation module 132 calculates the target outputs depending on the light sheet fine stack 220, the light sheet coarse stack 230 and the machine learning model 140.

According to the first embodiment, the machine learning model 140 is an aggregate processing model, the aggregate processing model is trained to calculate virtual light sheet fine stacks 260 from input light sheet coarse stacks 230.

In order to train the machine learning model 140, the target outputs are first determined. For the overall processing model, the target outputs are precisely image stacks 240 reconstructed from the light sheet fine stack 220 by means of a classical multi-angle reconstruction 135, see FIG. 4 (c). In the classical multi-angle reconstruction 135, image points of images 205 in the image stacks 210 to 214, which each capture the same point in the sample 120, are first determined from the different image stacks 210 to 214 of the light sheet fine stack 220 recorded at different exposure angles. For this purpose, all images 205 of the image stacks 210 to 214 are registered to the three spatial directions, so that the image points of the images 205 of the image stacks 210 are respectively assigned to voxels of the sample 120. Based on the registration, a new image value, a so-called reconstructed image value, is then assigned for the individual voxels respectively from the image signals of the image points of the different images 205 assigned to them, for example by averaging. This is preferably carried out for all captured voxels of the sample 120. More precise details of various methods for registering and subsequently combining the image stacks 210 to 214 are described in more detail, for example, in Temerinac-Ott, Maja, (2012), “Multiview reconstruction for 3D images from light sheet based fluorescence microscopy”.

According to the exemplary illustration, the light sheet fine stack 220 comprises precisely the five image stacks 210 to 214. If, for example, the shadow object 127 is considered, it is located in the shadow 126 of the opaque sample structure in the image stack 210 and accordingly has a considerably reduced image signal. In the image stack 210, however, the shadow object 127 is not shaded by the opaque sample structure 125, for which reason a considerably higher image signal is to be expected for the corresponding image point of the image stack 210 than for the image stack 210 in which the shadow object 127 lies precisely in the shadow 126 of the opaque sample structure 125.

If the different illumination angles and the height offsets in the image stacks 210 are now selected precisely such that shadow objects 127 are well illuminated in a plurality of the image stacks 210 to 214, a reconstructed image stack 240, or a reconstructed image, can be determined by means of the classical multi-angle reconstruction 135 for the image point of the shadow object 127 with a considerably higher image signal compared to the image 205 in which the shadow object 127 lies precisely in the shadow 126 of the opaque structure, therefore, the shadow object 127 can be readily identified in the reconstructed image stack 240; the shadows 126 can be eliminated or at least reduced.

An illumination angle corresponding to the reconstructed image stack 240 corresponds precisely to the illumination angle of the light sheet coarse stack 230. If the light sheet coarse stack 230 comprises a plurality of image stacks 210, a reconstructed image stack 240 is correspondingly determined for each of the image stacks 210 of the light sheet coarse stack 230. The plurality of reconstructed image stacks 240 then form the target outputs.

According to one configuration, the target outputs can also be a three-dimensional volume image in which a correspondingly reconstructed image value, which can also be called voxel value here, is assigned to each voxel.

In the following step S5 “determining learning inputs”, the learning inputs corresponding to the target outputs are determined. The learning inputs according to the first embodiment comprise a light sheet coarse stack 230 different from the light sheet coarse stack 230 recorded in step S1. According to step S5, the light sheet coarse stack 230 used for the training is determined from the light sheet fine stack 220. According to the first embodiment, the light sheet coarse stack 230 used for the training comprises precisely every second of the image stacks 210 to 214 of the light sheet fine stack 220, see FIGS. 4 (d) and 5 (a). The light sheet coarse stack 230 thus forms a proper subset of the light sheet fine stack 220.

Alternatively, every third or only every fourth of the image stacks 210 to 214 of the light sheet fine stack 220 recorded in step S3 could also be used as the learning inputs for the training. According to a further alternative, a light sheet coarse stack 230 can also be recorded separately from the light sheet fine stack 220, but in this case the image data 210 used for the training necessarily have to be recorded at the same location in the sample.

According to further alternatives, in each of the image stacks 210 of the light sheet fine stack 220, respectively, every second image within an image stack 210 can also not be transferred into the light sheet coarse stack 230, as illustrated in FIG. 5 (b). Even then, the light sheet coarse stack 230 is a proper subset of the light sheet fine stack 220.

In step S6 “creating an annotated data set comprising the target outputs and the learning inputs”, pairs of mutually corresponding learning inputs and target inputs are respectively compiled in the annotated data set. According to the first embodiment, this comprises, in particular, respectively compiling the above-described learning inputs and target outputs correspondingly to form learning pairs. According to one configuration, further learning pairs can also be formed by means of suitable augmenting, in order thus to write a greater amount of data into the annotated data set. The augmenting in particular comprises the above-described transformations.

In step S7 “optimizing the machine learning model for performing the virtual multi-angle reconstruction based on the annotated data set”, the control module 133 and evaluation modules 131 carry out a stochastic gradient method for optimizing the model parameters of the machine learning model 140 with the machine learning model 140. For this purpose, the control module 133 randomly selects a set of examples from the annotated data set in a plurality of successive training steps, inputs the learning inputs of the randomly selected set of examples into the machine learning model 140. The machine learning model 140 calculates the result data 152. The control module 133 determines the objective function for each learning pair, sums it over the learning pairs of the randomly selected set of examples, also referred to as batch, and optimizes the machine learning model 140 on the basis of a gradient determined from the objective function in a gradient descent algorithm.

The optimization of the machine learning model is carried out with various successive optimization steps until the objective function reaches a termination condition. If the termination condition is reached, the step S7 of training the machine learning model 140 is ended.

According to step S8, the control module 133 reads the light sheet coarse stack 230 recorded in step S1 from the memory module 132 and inputs the light sheet coarse stack 230 into the fully trained machine learning model 140. The light sheet coarse stack 230 in each case comprises only one image stack 210 of the sample 120. The machine learning model 140 calculates a virtual reconstruction 250 from the input image stack 210 and stores the virtual reconstruction 250 in the memory module 132.

According to the first embodiment, one or more reconstructed image stacks 240 are determined when determining the target outputs in step S4, wherein the reconstructed image stacks 240 have a considerably reduced number of shadow artefacts or stripe artefacts compared to the image stacks 210 of the light sheet fine stack 220 and the light sheet coarse stack 230, in the optimal case the reconstructed image stacks 240 no longer have any shadow artefacts at all, but this cannot always apply in particular for samples 120 with a high density of opaque sample structures 125. After the training, the machine learning model 140 outputs the virtual reconstruction 250, which also has a considerably reduced number of shadow artefacts 126 compared with the light sheet coarse stack 230 input into the machine learning model 140 as input data 150. Thus, as soon as a machine learning model 140 has been trained for the respective sample type, considerably fewer images have to be recorded in the further analysis or in further experiments with samples 120 of the respective sample type in order to eliminate or at least reduce shadow artefacts 126 in the recorded light sheet coarse stacks 230. The first embodiment thus provides a method for processing image data 200, recorded with a light sheet microscope, of samples of a specific sample type, in which a sample loading can be considerably reduced.

According to an alternative, step S3 can also be carried out before step S1, step S2 being omitted in this case. Steps S4 and S5 can also be carried out after step S3 and before step S1.

If, for example, it is known that no machine learning model is yet present, a light sheet coarse stack 230 does not first have to be recorded according to step S1, but rather the light sheet fine stacks 220 are recorded directly according to step S3, the light sheet fine stack 220 is processed by means of the classical multi-angle reconstruction 135 according to step S4 and the learning inputs are determined according to step S5 and the annotated data set is provided according to step S6. According to step S7, the machine learning model 140 is then trained and the light sheet coarse stack 230 to be processed is subsequently recorded according to step S1 and processed by means of the fully trained machine learning model 140.

According to an alternative, the annotated data set stored on the memory module 132 consists only of a single learning pair, consisting of a light sheet coarse stack 230 as the learning inputs and the reconstructed image stack 240. During the training step S7, the control module 133, for example, then carries out the augmentation described with reference to the first embodiment in each case randomly before input of the learning pair into the machine learning model 140. Alternatively, however, a plurality of light sheet coarse stacks 230 and a plurality of light sheet fine stacks 220 can also be recorded for the training.

According to one configuration of the first embodiment, during the calculation of the target outputs, a plurality of candidate reconstructed stacks are calculated; the plurality of candidate reconstructed stacks are subsequently compared in order to determine a reconstruction with a highest reconstruction quality. The best reconstruction can be determined, for example, based on a metric which acquires image properties such as, for example, a number of stripe artefacts or stripe artefacts, an image sharpness, an image contrast, a brightness distribution, a color distribution, or the like. In the calculating of the plurality of candidate reconstructed stacks a different set of parameters is used for each of the plurality of candidate reconstructed stacks, wherein the used set of parameters in particular specifies the classical multi-angle reconstruction 135, in particular a reconstruction algorithm and parameters used in the reconstruction algorithm, for example correction parameters, a number of iterations of the used algorithm, used correction methods and correction parameters for the respectively used correction methods. The images of the candidate stack which, according to the metric, supplies the best reconstruction, i.e. the best reconstruction result, are finally selected as the target outputs.

According to one configuration of the first embodiment, a fully trained machine learning model 140 for a sample 120 of the sample type to be examined is already stored in the memory module 132. As already described further above, the virtual multi-angle reconstruction reacts very sensitively to changes in the optical properties of the different sample types. The different sample types can be distinguished, for example, on the basis of optical properties of sample structures of a sample, in particular the optical properties of the opaque or partially opaque sample structures 125. The optical properties can comprise one or more of the following properties: for example, the extent thereof, the opacity thereof, the spectral transmittance thereof, usable fluorophores and a density of the opaque sample structures in the sample of the respective sample type.

For example, a light sheet coarse stack 230 to be processed can first be recorded, after which the light sheet coarse stack 230 is virtually reconstructed using a plurality of possibly suitable fully trained machine learning models 140 stored in the memory module 132, the virtual reconstructions 250 respectively produced by the different machine learning models 140 are then checked by means of a suitable metric, for example a number of stripe artefacts in the virtual reconstructions 250 or similar image properties which acquire a quality of the virtual reconstruction 250, whether one of the machine learning models 140 used creates the virtual reconstructions 250 in a sufficient quality. If this is the case, no further light sheet fine stack 220 has to be recorded and the sample can be evaluated with the respective machine learning model 140. As a result, a light loading of the respective sample can be further reduced since no further light sheet fine stack 220 has to be recorded. If, however, the verification reveals that the prepared virtual reconstructions 250 do not meet the quality requirements, then corresponding to step S3 for recording a light sheet fine stack 230 and the corresponding following steps for training a new machine learning model 140 are carried out.

In principle, when carrying out an experiment at regular intervals, a respective prepared virtual reconstruction 250 can be checked with regard to the quality of the reconstruction as described above. For example, in the case of temporally variable samples 120, a deterioration of the reconstruction quality can occur in the course of an experiment. It can be attributed in particular to the change in the optical properties of the temporally variable sample 120. If such a deterioration of the reconstruction quality is detected, new training is again carried out with a new machine learning model 140 with a reconstructed image stack 240 determined from a newly recorded light sheet fine stack 220.

According to a further configuration, during the recording of the image stacks 210, a respective tilting device can also be used which tilts the light sheet 110 along the z-axis with a high frequency, for example 1 kHz, a few kHz, 1-10 kHz or 1-20 kHz, for example by up to 10°, such that during the recording of each of the images 205 of an image stack 210, the direction of the light sheet 110 respectively oscillates by 10° about a rest position at 0°. As a result, the shadow artefacts 126 can already be reduced with the recording of an individual image 205, but often cannot be completely eliminated, for which reason light sheet fine stacks 220 are also recorded for light sheet microscopes with a tilting device, in order to further reduce the shadow artefacts with the classical multi-angle reconstruction 135.

According to a further configuration, the classic multi-angle reconstruction 135 also comprises a deconvolution with a point spread function.

According to the first embodiment, the machine learning model 140 is a U-Net, in particular a generative adversarial network, GAN for short, an implemented U-Net.

Generative adversarial networks comprise at least one generator and one discriminator. In the present case, the generator receives the light sheet coarse stacks as learning input and generates the virtual reconstruction therefrom. The discriminator receives either the output of the generator or an image stack 240 of the annotated data set reconstructed from the light sheet fine stack as input data. The output of the discriminator is also called discrimination result. The discrimination result indicates whether the input image is a virtual reconstruction 240 output by the generator or a reconstructed image stack 240 of the training data set. The generator and the discriminator are trained jointly. In a joint objective function of the generator and of the discriminator, the outputs thereof are captured. In the objective function, the generator is penalized if the discriminator identifies result data output by the generator as such and the discriminator is penalized if it incorrectly classifies virtual reconstructions 250 output by the generator as reconstructed image stack 240.

Very different objective functions are used in the training of GANs. Customary objective functions comprise, for example, a minimax-loss or also a Wasserstein-loss.

According to one modification, the discriminator can be implemented as a semantic segmenter. The discriminator can output, for example, image point by image point, whether the respective image point was generated by the generator or originates from the annotated data set.

As a further alternative, the discriminator can also be a so-called patch classifier. In contrast to the semantic segmenter, the discriminator does not check image point by image point whether the input images are generated data or data of the training data set, but rather based on field of view. patches, and then sums over results of the patches in order to determine whether an input originates from the generator or from the training data set. The size of the patches can in particular be suitably adapted.

Further suitable configurations both of the discriminator and of the target functions are known to the person skilled in the art from the prior art, for which reason he has no difficulties in implementing further configurations here as well.

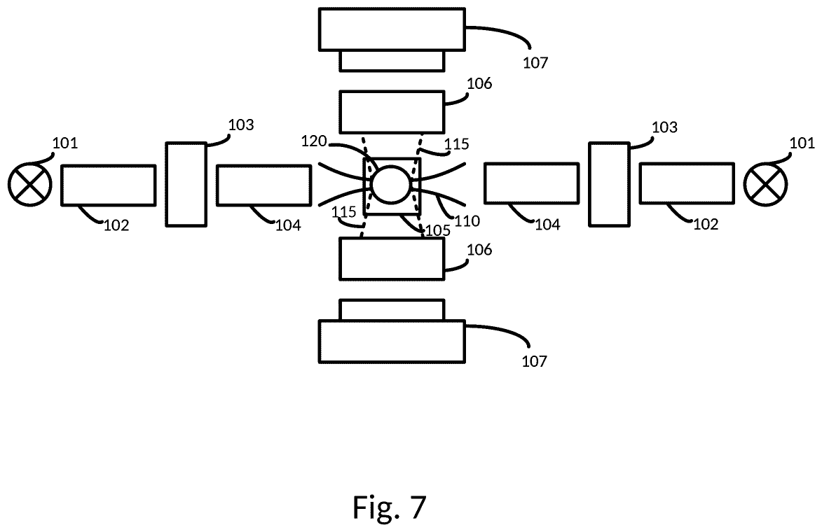

According to a second embodiment, the sample 120 is illuminated from two sides with overlapping light sheets 110. This can be implemented, for example, by suitable mirrors and beam splitters which deflect the light sheet 110 such that the sample 120 is illuminated from both sides. Alternatively, however, a second light source 101 can also be used which illuminates the sample from an opposite side, as illustrated schematically in FIG. 7. In order to form the light sheet 110, the imaging device 100 in turn comprises, in addition to the light source 101, a beam expander 102, a lens 103 and an illumination objective 104.

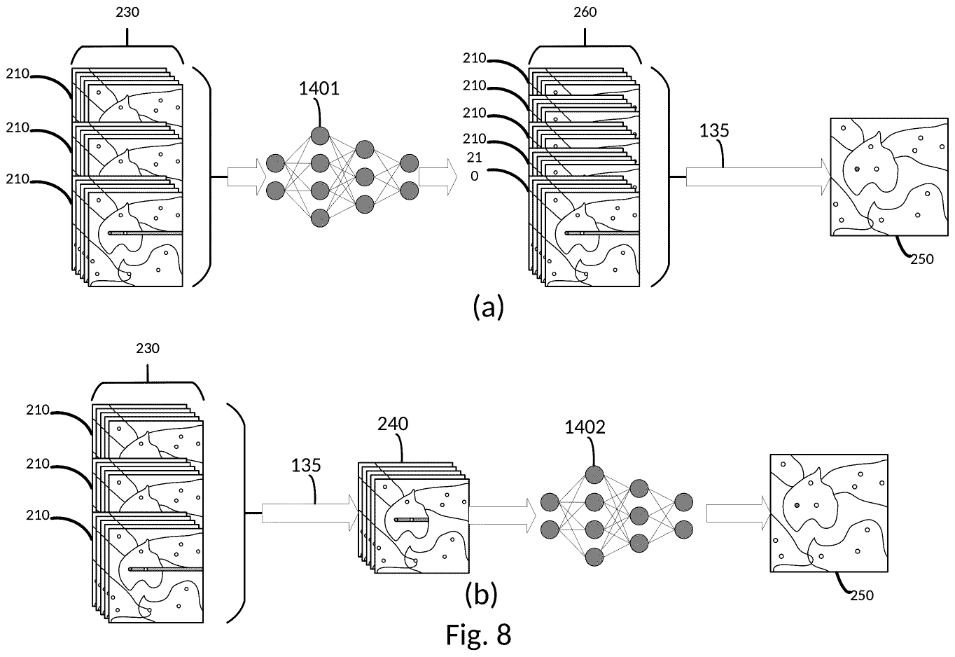

In addition, a second camera 107 with a corresponding detection objective 106 can also be provided.

Whereas, according to the first embodiment, the machine learning model 140 is an aggregate processing model, the machine learning model 140 is configured as a stage processing model according to a second embodiment. As illustrated by way of example in FIGS. 8 (a) and (b), the processing of the image data 200 according to the stage processing model is carried out in a plurality of stages.

As illustrated, the machine learning model 140 implemented as a stage processing model comprises a detail enhancement model, which is trained for performing a detail enhancement mapping, and a reconstruction model, which performs the classical multi-angle reconstruction 135.

According to FIG. 8 (a), the stage processing model initially comprises a first detail enhancement model 1401 which is configured or trained to map a recorded light sheet coarse stack 230 onto a virtual light sheet fine stack 260. The output virtual light sheet fine stack 260 is subsequently processed by means of the classical multi-angle reconstruction 135. The output is in turn referred to as virtual reconstruction 250, since it is based on a virtual light sheet fine stack 260. Correspondingly, in the second embodiment, the target data differ from the target data of the first embodiment to the effect that the target data of the second embodiment according to the alternative according to FIG. 8 (a) comprise precisely the light sheet fine stacks 220.

Also according to the second embodiment, during the execution of the classical multi-angle reconstruction 135, as described with reference to the first embodiment, candidate stacks can in turn be calculated. According to this embodiment, these would then be called virtual candidate stacks, and a best virtual reconstruction 250 is in turn selected on the basis of the virtual candidate stacks. In contrast to the first embodiment, however, the best virtual reconstruction 250 is then not part of the training data set, but rather the best virtual reconstruction 250 is respectively determined during the inference.

According to an alternative configuration, the order in which the reconstruction model and the detail enhancement model are applied can be interchanged in the stage processing model. As illustrated in FIG. 8 (b), the classical multi-angle reconstruction 135 is first applied to the light sheet coarse stack 230. A resulting reconstructed image stack 240 is also referred to as reconstructed light sheet coarse stack. The reconstructed light sheet coarse stack has more shadow artefacts or stripe artefacts compared with a reconstructed image stack 240 determined based on the light sheet fine stack 220, which is also referred to as reconstructed light sheet fine stack. According to this configuration, a second detail enhancement model 1402 is trained to map the reconstructed light sheet coarse stack onto a light sheet fine stack. The fully trained second detail enhancement model 1402 should then output a virtual reconstruction 250 which has approximately as many shadow artefacts as the reconstructed light sheet fine stack. According to the configuration according to FIG. 8 (b), the learning inputs comprise the reconstructed light sheet coarse stack, that is to say the reconstructed image stack 240 calculated from the light sheet coarse stack 230 by means of the classical multi-angle reconstruction 135, and the target outputs again comprise the reconstructed image stacks 240, but the image stack 240 reconstructed from the light sheet fine stack 220.

The light sheet coarse stack can in particular comprise only a single image stack. Correspondingly, in the case of the stage processing model in which the reconstruction model is applied first, the classical multi-angle reconstruction would be applied only to the individual image stack and the detail enhancement model would subsequently be applied to the reconstructed light sheet coarse stack. During the application of the classical multi-angle reconstruction to the individual image stack, an averaging over a plurality of image stacks then correspondingly takes place, for example, if the multi-angle reconstruction comprises the averaging only of the individual image stack. However, the classic multi-angle reconstruction often also comprises other steps, for example a deconvolution of the images of the respective image stack, for example a Richardson-Lucy deconvolution, or other image preparation algorithms. If the light sheet coarse stack now comprises only the one image stack, the reconstruction model would also carry out the deconvolution, as a result of which the image quality is improved to a certain extent with respect to the non-deconvoluted image stack. In the training of the detail enhancement model, the unfolded image stacks would be used as learning input and the image stack 240 reconstructed from the light sheet fine stack would be used as target output. Thus, as described above, the detail enhancement model will use the individual image stacks as learning inputs and the image stacks of the light sheet fine stack from target outputs.

The variants and configurations described for the different figures can be combined with one another. The configurations shown and described are purely illustrative and modifications thereof are possible within the scope of the appended claims.

1. A method for training an image processing system with a machine learning model for performing a virtual multi-angle reconstruction of image stacks, in particular a sample of a sample type, recorded with a light sheet microscope, comprising:
recording at least one light sheet fine stack of a sample, wherein the light sheet fine stack comprises a plurality of image stacks and for different ones of the image stacks a light sheet shines through the sample at a different angle,
determining target outputs based on the light sheet fine stack, the machine learning model and a classical multi-angle reconstruction,
determining learning inputs based on a light sheet coarse stack, the machine learning model and the classical multi-angle reconstruction, wherein the light sheet coarse stack comprises one or more image stacks and for different ones of the image stacks the light sheet shines through the sample at a different angle,
creating an annotated data set comprising the target outputs and the learning inputs,
optimizing the machine learning model for performing the virtual multi-angle reconstruction based on the annotated data set, wherein
the light sheet coarse stack comprises fewer images than the light sheet fine stack, in particular fewer image stacks, and a virtual reconstruction determined by means of the virtual multi-angle reconstruction has fewer image artifacts than a reconstructed image stack determined from the light sheet coarse stack by means of the classical multi-angle reconstruction.

2. The method according to claim 1, wherein determining the learning inputs comprises one or more of the following:
recording the light sheet coarse stack, wherein when recording the light sheet coarse stack fewer different image stacks, fewer different angles or fewer images are recorded per image stack,
determining the light sheet coarse stack from the light sheet fine stack, wherein the light sheet coarse stack is a proper subset of the light sheet fine stack, the light sheet coarse stack comprises only every second, third or fourth of the image stacks recorded when recording the light sheet fine stack or comprises for each image stack of the light sheet coarse stack only every second, third or fourth image of the respective image stack, particularly the light sheet coarse stack comprises only a single image stack.

3. The method according to claim 1, wherein before recording the light sheet fine stack one or more recording parameters are determined depending on a sample type for which the training is performed such that regions in the sample which are arranged in the sample behind opaque or partially opaque sample structures are illuminated in at least one of the recorded image stacks or are partially illuminated at least in a plurality of the image stacks of the light sheet fine stack, the recording parameters comprising one or more of the following recording parameters:
a height offset of height-offset images in an image stack,
a number and an angular distance of the different angles,
an exposure spectrum,
fluorophores used, and
context information; and furthermore
the sample type is determined based on one or more of the following properties of opaque or partially opaque sample structures:
an extent,
an opacity,
a spectral transmittance,
usable fluorophores, and
a density in the sample of the sample type.

4. The method according to claim 1, wherein the machine learning model is a stage processing model or an overall processing model, the stage processing model comprises a detail enhancement model and a reconstruction model, the reconstruction model is configured to calculate the classical multi-angle reconstruction, the detail enhancement model is trained using the annotated data set for performing a detail enhancement mapping, and performing the classical multi-angle reconstruction and the detail enhancement mapping in succession yields the virtual multi-angle reconstruction, depending on an order in which the detail enhancement model and the reconstruction model are applied, the detail enhancement model is either trained to map a reconstructed light sheet coarse stack calculated by means of the classical multi-angle reconstruction onto a reconstructed light sheet fine stack or to map the light sheet coarse stack onto the light sheet fine stack, and determining the learning inputs and the target outputs depending on the order in which the detail enhancement model and the reconstruction model are applied comprises: selecting a reconstructed light sheet coarse stack or selecting a reconstructed light sheet fine stack as the learning inputs and selecting a reconstructed light sheet fine stack or selecting a light sheet fine stack as the target outputs, and
if the machine learning model is the overall processing model, the overall processing model is directly trained by means of the annotated data set for performing the virtual multi-angle reconstruction, in particular the virtual multi-angle reconstruction comprises the detail enhancement mapping and the classical multi-angle reconstruction, and determining the annotated data set comprises: selecting a light sheet coarse stack comprising at least one image stack as learning inputs and selecting at least one reconstructed light sheet fine stack determined from the light sheet fine stack by means of the classical multi-angle reconstruction as the target outputs.

5. The method according to claim 1, wherein determining the target outputs from the light sheet fine stack comprises:
calculating, by means of the classical multi-angle reconstruction, a plurality of candidate reconstructed stacks, wherein for each of the plurality of candidate reconstructed stacks a different set of reconstruction parameters of the classical multi-angle reconstruction is used, wherein by means of the parameters used, for example, a reconstruction algorithm used, a number of iterations in applying the reconstruction algorithm, correction methods used or correction parameters of the correction method used are selected,
checking the candidate stacks, and
selecting the target outputs from the candidate reconstructed stacks.

6. The method according to claim 1, wherein optimizing the machine learning model comprises augmenting the annotated data set or simulating further data using a point spread function as well as the target outputs of the annotated data set, wherein the point spread function is, for example, a depth-variant point spread function.

7. The method according to claim 1, after optimizing the machine learning model, further comprising checking the machine learning model whether the machine learning model is suitable for reconstructing the light sheet coarse stack by means of the learned virtual multi-angle reconstruction.

8. A method for performing a virtual multi-angle reconstruction of image stacks recorded with a light sheet microscope with an image processing system comprising a machine learning model, comprising:
providing a machine learning model for performing the virtual multi-angle reconstruction, wherein a machine learning model is used which has been trained according to the method for training an image processing system according to claim 1,
recording, by means of a light sheet microscope, a light sheet coarse stack to be processed, comprising at least one image stack of the sample of the sample type,
calculating a virtual reconstruction from the light sheet coarse stack by means of the virtual multi-angle reconstruction.

9. The method according to claim 8, wherein before calculating a virtual reconstruction, the method further comprises:
checking one or more machine learning models whether the machine learning models are suitable for reconstructing the light sheet coarse stack to be processed by means of the respectively learned virtual multi-angle reconstruction, and,
if no suitable machine learning model is present:
performing the method for training the image processing system with the sample, wherein in particular the recording of the light sheet fine stack takes place in a predetermined region of the sample and in particular the recording of the light sheet coarse stack to be processed takes place in a region of the sample different from the predetermined region.

10. The method according to claim 9, wherein checking the one or more machine learning models comprises:
inputting the light sheet coarse stack into the machine learning model and checking the output virtual reconstruction, comprising:
a manual checking,
a comparison with example target outputs,
a determination of a quality metric, in particular based on image properties of the virtual reconstruction, for example image sharpness, edge sharpness, number of image artifacts such as stripe artifacts, in particular by means of a metric quality model, wherein the metric quality model is set up, in particular trained, for identifying image properties,
an inputting into a quality classification model which has been trained for classifying virtual reconstructions and/or classical multi-angle reconstructions,
checking based on image features such as, for example, image sharpness, noise level, blood flow, artifacts such as ring and stripe artifacts.

11. An image processing system comprising an evaluation device for performing a method according to claim 1.

12. The image processing system according to claim 11, further comprising an imaging device, in particular a light sheet microscope.

13. A computer program product comprising commands which, when the program is executed by one or more computers, cause the latter to perform the method according to claim 1, the computer program product being in particular a computer-readable storage medium.
